(19) United States
(12) Patent Application Publication
(10) Pub. No.: US 2011/0088217 A1
(43) Pub. Date: Apr. 21, 2011

(54) HINGE FOR A WINDOW OR DOOR ASSEMBLE

(76) Inventors: Eirik Bjørn, Ringkobing (DK); Anne Christina Boiskau Hansen, Odense M (DK)

(21) Appl. No.: 12/736,265

(22) PCT Filed: Aug. 21, 2008
(86) PCT No.: PCT/EP2008/060971

§ 371 Date: Nov. 12, 2010

(30) Foreign Application Priority Data
Mar. 26, 2008 (EP) 08153351.5

(51) Int. Cl. E05D 7/04; E05D 5/02

(52) U.S. Cl. 16/235; 16/382

(57) ABSTRACT

A hinge (5) suitable for a window or door assembly comprising a frame (2) and a sash (3) pivotably arranged with respect to each other, where said frame is of the type comprising four frame members (2a-2d) arranged in a rectangular arrangement and where said sash is of the type comprising four sash members (3a-3d) arranged in a rectangular arrangement, where said hinge comprises a first flange (51) arranged to be fixed to a first frame member (2d) and a second flange (52) arranged to be fixed to a first sash member (3b) and where the two flanges are pivotably connected to each other about a pivot axis which is arranged parallel to the longitudinal axis of said first frame member and said first sash member, and where said hinge further comprises a third flange (73) which is attached to said first flange and which is arranged essentially perpendicular to the first flange, said third flange being arranged to be fixed to a second frame member (2a), said second frame member being arranged essentially perpendicular to the first frame member, and where the hinge further comprises a fourth flange (74) which is attached to said first flange and which is arranged at an angle to the first flange of between 60° and 120°, said fourth flange being arranged to be fastened to the first frame member.

The current invention relates to a hinge suitable for a window or door assembly comprising a frame and a sash pivotably arranged with respect to each other, where said frame is of the type comprising four frame members arranged in a rectangular arrangement and where said sash is of the type comprising four sash members arranged in a rectangular arrangement, where said hinge comprises a first flange arranged to be fixed to a first frame member and a second flange arranged to be fixed to a first sash member and where the two flanges are pivotably connected to each other about a pivot axis which is arranged parallel to the longitudinal axis of said first frame member and said first sash member, and where said hinge further comprises a third flange which is attached to said first flange and which is arranged essentially perpendicular to the first flange, said third flange being arranged to be fixed to a second frame member, said second frame member being arranged essentially perpendicular to the first frame member.

This description of the window/door assembly above should describe the vast majority of window/door assemblies currently available and should not in general be limiting to the scope of protection of the claims. Usually a plate element is arranged in the sash. The plate element could take many different forms, for example a single, double or triple pane of glass. The plate element could also be a blind plate element used to prevent light from passing through the plate element. The sash is arranged around the plate element to hold the plate element. When mounted, the frame is arranged in the window/door opening and the sash is connected to the frame via the hinges. Usually the frame element is the outermost element of the window/door assembly, but in certain cases, the sash element could overlap the frame element. The hinges disclosed herein are typically used with window/door assembly which are top hinged or side hinged.

In most top and side hinged window/door assemblies, locking fittings will typically be provided to lock the window/door in the closed position and/or in the open position. Locking fittings could take many forms. One typical example is an espagnolette mechanism. Usually the hinges and the locking fittings are separate entities, but in certain window/door assemblies, one could imagine that the hinges and locking fittings were combined into a single fitting, with two separate functions.

### DESCRIPTION OF RELATED ART

Outwardly opening window/door assemblies of the kind to which the hinges of the current invention could be applied are well known in the art. Most such hinges only comprise two flanges, one connected to the frame and one connected to the sash. An example of such a hinge is shown in JP2008-075267. However, hinges comprising three flanges as mentioned in the introductory paragraph can be found in the prior art. An example of such a hinge is disclosed in JP3634776B2.

Common design goals when designing a hinge for a window/door assembly of the above mentioned kind are high strength, low production costs, low height (dimension parallel to the plane of the frame and perpendicular to the frame member to which the hinge is attached), simple and straightforward installation, good break in protection and easy adjustability. These design goals are met with varying degrees of success by the currently available hinges.

### SUMMARY OF THE INVENTION

One aspect of the current invention is therefore to provide a hinge for a window/door assembly which fulfils the above mentioned design goals in a way which is better and/or different than the prior art hinges.

This aspect is provided by a hinge according to the introductory paragraph and where the hinge further comprises a fourth flange which is attached to said first flange and which is arranged at an angle to the first flange of between 60° and 120°, said fourth flange being arranged to be fastened to the first frame member. In this way, the hinge can be attached to the frame in a manner which allows the frame to be made much thinner. The hinges are able to be attached with screws for example, which screw into the main body of the frame, instead of being screwed into a forwardly protruding portion of the frame. This allows the forwardly protruding portion of the frame to be minimized or even removed.

It should be mentioned that in the current specification, the terms used to describe the window are meant to be understood according to a window or door assembly when mounted in a wall opening of a typical house. The terms “inside” and “outside”, innermost, outermost, etc should be interpreted as being inside and outside the house respectively. The terms “inner surface” and “outer surface” should be understood as the surface which is closest the inside of the house and the surface which is closest to the outside of the house respectively. The term “periphery” should be understood as the outer perimeter of the window assembly. For example, “facing the outer periphery” should be understood as facing along a direction which goes from the centre of the window towards the outer edge of the window assembly.

The term “surface” should be understood rather broadly and according to its common meaning, in other words the surface of an element. It does not have to be planar or flat.

Additional features and embodiments of the window assembly are disclosed in the dependent claims. Additional inventions are disclosed in the additional independent claims.

A number of additional terms used in the claims are defined here for the sake of clarity. An outwardly or forwardly protruding flange is a flange which protrudes away from an element in a direction towards the outside of the window assembly. An inwardly or rearwardly protruding flange is a flange which protrudes away from an element in a direction towards the inside of the window assembly. The outermost edge of an object is that edge which is closest towards the outside of the window assembly. Co-planar is meant to be two elements which lie on essentially the same plane. Essentially, is defined as being as close to the stated criteria as possible such that the invention is fulfilled. For example, if two elements are said to be essentially co-planar, then the elements should be on the same plane, but if they are slightly away from the same plane, but still fulfil the objective of the invention, then they should still be considered to be co-planar.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to the embodiments shown by the enclosed figures. It should be emphasized that the embodiments shown are used for example purposes only and should not be used to limit the scope of the invention.

FIG. 1 shows a first perspective view of an embodiment of a complete outwardly opening side hinged window assembly comprising hinges according to the current invention.

FIG. 2 shows a perspective detailed view of one embodiment of an upper corner hinge.

FIG. 3 shows an exploded perspective view of the hinge of FIG. 2.

FIG. 4 shows a cross section view of a hinge according to the invention together with a frame member and a sash member according to the line IV-IV defined in FIG. 1.

FIG. 5 shows a perspective exploded perspective view of a centre hinge which is used in the window assembly of FIG. 1.

FIG. 6 shows a perspective view of a second embodiment of a window assembly having hinges according to the invention.

FIG. 7 shows a perspective detail view of the corner hinge of FIG. 6.

FIG. 8 shows a perspective detail view of a centre hinge of FIG. 6.

FIG. 9 shows a detailed perspective view of a top corner hinge.

FIG. 10 shows an exploded detailed perspective view of the hinge of FIG. 9.

FIG. 11 shows an exploded perspective view of a centre hinge.

FIG. 12 shows a detailed perspective view of a lower corner hinge.

FIG. 13 shows a detailed perspective view of another embodiment of a lower corner hinge.

FIG. 14 shows a cross section view of a hinge according to the invention when connected to a frame member and a sash member.

FIG. 15 shows a perspective view of another embodiment of a corner hinge.

FIG. 16 shows a perspective view of still a further embodiment of a corner hinge.

### DETAILED DESCRIPTION OF THE EMBODIMENTS

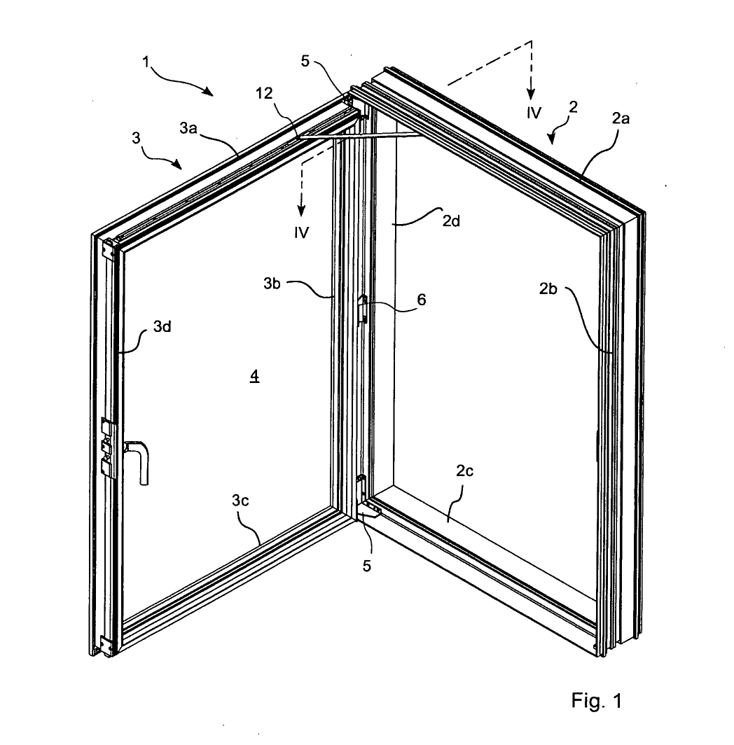

FIG. 1 shows an outwardly opening side hinged window assembly 1. The window assembly comprises a window frame 2 made up of four frame elements or members 2a, 2b, 2c, 2d connected together with mitre joints, a window sash 3 made up of four sash elements 3a, 3b, 3c, 3d connected together with mitre joints and a triple glazed pane of glass 4 arranged inside the window sash 3. Two corner hinges 5 and a centre hinge 6 connect the sash 3 to the frame 2.

Since this specification is primarily concerned with the hinges, additional details of the window assembly will not be discussed further in this specification. Additional details of the window assembly of the figures can however be found in European Patent Application EP 08153351. The reader of this specification is therefore referred to said specification should any details discussed in this current specification need extra clarification.

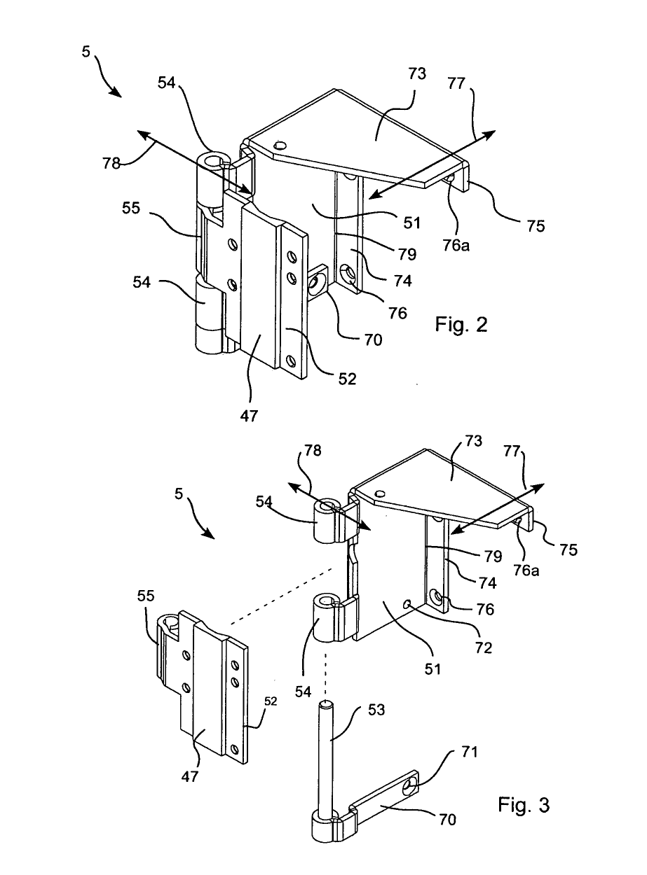

FIGS. 2 and 3 show more details of the corner hinges 5 used in the current embodiment. The figures show the top corner hinge (a top left hinge when looking at the window from the outside). The bottom corner hinge is very similar in function and design and will therefore not be described further herein. The hinge 5 comprise two flanges 51, 52 where a first flange 51 is attached to the frame member 2 and a second flange 52 is attached to a sash element 3. The first flange comprises two cylindrical elements 54 attached along one edge of the flange and the second flange comprises one cylindrical element 55 attached along one edge of the flange. The two cylindrical elements of the first flange are arranged one on either side of the cylindrical element of the second flange when the hinge is assembled. A pin 53 is inserted through the cylindrical elements to allow the two flanges to pivot with respect to each other. This type of construction should be familiar to the person skilled in the art and the person skilled in the art should be able to provide a number of equivalents to this type of joint.

The pin 53 of the current embodiment is formed as an elongated cylindrical element which is sized to fit inside cylindrical channels of the cylindrical elements 54, 55 of the flanges. A mounting flange or tab 70 is attached to the pin at one end and extends away from the pin as a sort of elongated handle. The mounting flange serves two purposes. The first purpose is to make it easier to manually place the pin in the cylindrical elements. Due to the small amount of space available between the flanges of the hinge and due to the small amount of space between the frame members and sash elements, it can be difficult to mount the pin manually, especially for people with large fingers. The flange makes it possible to easily guide the pin into the correct position. The second purpose is to secure the pin once it has been mounted. The flange is therefore formed with a hole 71 through which a screw (not shown) can be placed. The screw engages with a corresponding hole 72 in the first flange. The screw can therefore be used to attach the mounting flange of the pin to the first flange of the hinge. In this way, the pin is secured so that it cannot fall out. In addition, the flange also secures the pin in the case of an attempted break in. Since the axis of the screw is parallel with the plane of the window assembly, it is necessary for the window to be open in order to access the screw. When the window is in the closed position, it is impossible to get access to the screw and a thief will not be able to simply remove the pin of the hinge to gain access to the window.

Since the hinge shown in FIGS. 2 and 3 is to be mounted at the corner of the window assembly, it comprises a third flange 73 which is integrated with the first flange and at a right angle thereto. The third flange can therefore be attached to a second frame member 2a at the corner. In this way, the corner hinges are connected to both frame elements 2a, 2d at the corner. This allows the weight of the window sash to be transferred to both frame members. It also strengthens the joint between the frame members.

In the current embodiment, a fourth 74 and a fifth flange 75 are also disclosed. The fourth flange 74 is attached to the first flange and extends at a right angle thereto. The fifth flange 75 is attached to the third flange and extends at a right angle thereto. Both fourth and fifth flanges 74,75 are arranged in a plane which is parallel to the plane of the window assembly. The fourth and the fifth flanges are provided with holes 76 through which screws can be placed. These screws are used to fasten the hinge to the frame member. As can be seen from the figures, in this particular embodiment, the first and third flanges are not themselves fastened to the frame members, but are fixed to the frame members via the fourth and fifth flanges. While it cannot be seen in the figures, the fourth and fifth flanges are not directly connected to each other, rather, they are only connected via the connection between the first and third flanges.

The third flange 73 can also be used to adjust the position of the pivot axis of the hinge. An adjusting screw (not shown) can be placed in the outermost hole 76a of the fifth flange. By adjusting this screw so that the third flange moves in and out, as shown by the arrow 77, the pivot axis of the hinge can be displaced along an axis which is parallel to the plane of the window assembly and parallel to the third flange as shown by the arrow 78. This adjustment possibility is especially interesting in the top hinge of a side hung window since it will allow the hinge to be adjusted to compensate for the sag of the window sash over time.

It is to be noted that the adjustment in this case is enhanced by the fact that the first flange is not directly fastened to the frame. The fourth flange is fastened to the frame and the hinge is able to bend slightly about the bend line 79. This is also the reason that the fourth and fifth flanges are not directly connected to each other. Connecting the fourth and fifth flanges together would increase the stiffness of the hinge, which would therefore require more strength to adjust. The stiffness of the hinge therefore needs to be chosen depending on the desire of the designer and a tradeoff between stiffness and adjustability needs to be made. The adjustment is also enhanced by the large distance between the attachment of the first flange to the frame and the pivot axis of the hinge. Furthermore, the adjustment is also increased by the large distance between the pivot axis of the hinge and the adjustment mechanism on the third flange (screw in the hole 76a in the fifth flange)

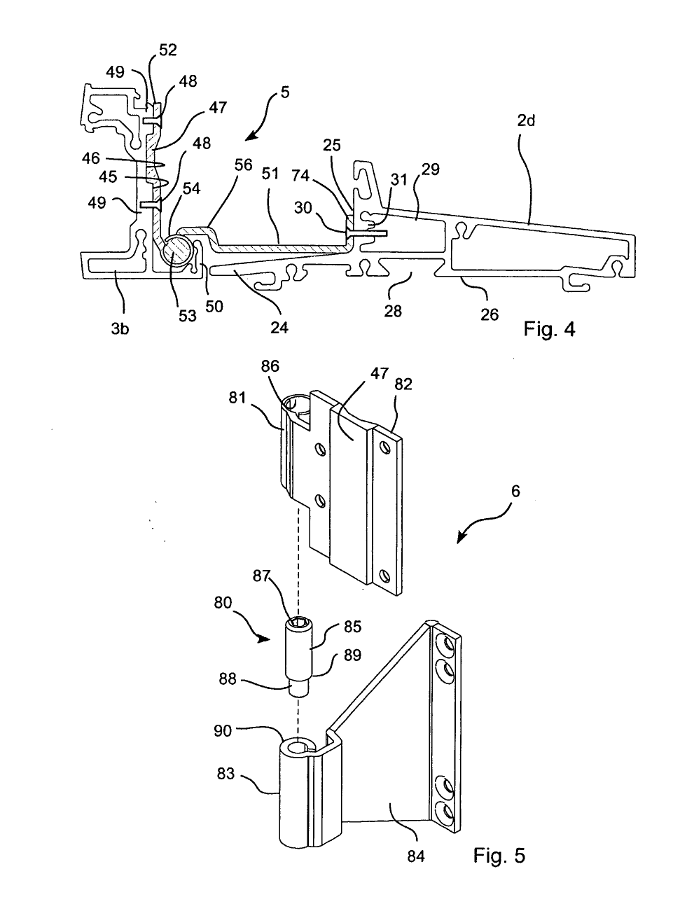

FIG. 4 shows a cross section through the frame member 2d and the sash member 3b in cross section together with the upper corner hinge 5 (as shown in FIGS. 2 and 3). The hinges transfer the weight of the window sash to the window frame. Especially when the window is open, the majority of the forces due to the weight of the window sash are transferred to the window frame via the hinges.

As can be seen from the figure, the fourth flange 74 which attached to the first flange 51 of the hinge is fastened to the frame member 2d and the second flange 52 is fastened to the sash element 2b. The flanges are fastened to the sash and frame members respectively with screws 30, 48. However, other forms of fastening could also be imagined, for example snap mechanisms, adhesives, mechanical bonding for example welding, etc.

As can also be seen from the figure, the dimension of the first and second flanges in the direction which is perpendicular to the plane of the window assembly, when the window is closed, is quite large. This is due to the fact that the point of rotation of the sash is located quite far forward with respect to the surface 25 of the frame member to which the first flange 51 is fixed. This is in contrast to most other types of window assemblies where the hinges are much smaller but are attached much more forward on the frame members. In the current embodiment, large demands are therefore placed on the strength of the mounting fittings. This is however easily achieved with strong materials such as high strength steel. This is also supported by the construction of the hinge with the right angled first and third flanges (51, 74). In the other types of window assemblies, large demands are placed on the frame members. This is usually solved either with a thick frame member which is visually non-appealing or with a very strong forward portion of the frame member. This strong forward portion however makes the frame member rather expensive since the strong forward portion typically extends the entire length of the frame member. In the current embodiment, the forwardly protruding flange of the frame can be relatively weak (or not even present) and the hinges are very strong. Therefore strength is placed only there were it is necessary.

As shown in FIG. 4, the hinges are attached to the sash via a surface 45 of the sash which faces the periphery of the window assembly and the periphery of the window opening when the window is closed. A groove 46 is formed in the surface 45 into which a corresponding protrusion 47 of the hinge is arranged. This increases the contact surface between the hinge and the sash and also increases the strength of the connection between the hinge and the sash. Screws 48 are used to attach the hinge to the sash. The screws are placed through thickened portions 49 of the lower surface 45 of the sash.

The sash element also comprises a rearwardly pointing or inwardly protruding flange 50. The rearwardly pointing flange 50 is arranged at the same height as the forwardly pointing flange 24 of the frame member when the window is closed. In this way, the two flanges are co-planar and almost touch each other. In the current embodiment there is a gap of around 8 mm between the two flanges. A rubber seal (not shown) is attached to the rearwardly pointing flange in order to seal the gap. Due to the construction of the frame members and the sash elements, the area in which the hinges are arranged is entirely enclosed and protected from the weather.

Due to the rearwardly pointing flange of the sash member, the hinge needs to be designed in a special way such that there is room for the rearwardly pointing flange of the sash when the window is opened. The first and second flanges 51,52 of the hinge are therefore arranged such that in the closed position of the window, the parts of the flanges which are closest to the cylindrical element are formed such that they are offset from a plane which goes through the pivot axis of the hinge in a direction towards the centre of the window assembly. For example, in the current embodiment, the first flange 51 is formed with a U-shaped portion 56 where a portion of the U-shaped portion is arranged offset from a plane going through the pivot axis of the hinge. The second flange 52 is attached to the cylindrical portion of the hinge such that the entire flange is offset from a plane going through the pivot axis of the hinge. Due to this offset, the rearwardly pointing flange of the sash element can be made quite large without having the rearwardly pointing flange interfering with the first and second flanges of the hinge when the window is opened.

It should be noted that in the example embodiment shown in the figures, the first flange and third flanges of the hinges are arranged perpendicular to the plane of the frame and perpendicular to each other. However, it would be possible to arrange the first and third flanges at an angle to the vector which is perpendicular to the plane of the frame. For example in FIG. 4, it could be imagined that the first flange 51 was arranged such that it was flush with the forwardly protruding flange of the frame member. The third flange could also be arranged flush with the frame in the same manner. In this case, the first and third flanges will not be explicitly perpendicular to each other, however, according to the understanding of this specification, they should still be considered perpendicular since the longitudinal axes of the two flanges are perpendicular to each other.

The same discussion could also be made with regards to the fourth and fifth flanges 74,75. For example, in the embodiment shown in FIG. 4, the fourth flange is perpendicular to the first flange and parallel to the plane of the frame. However, it could be imagined that the flange were arranged at another angle than 90°. For example, the surface of the frame member could be angled towards the inside of the window assembly or towards the outside of the window assembly. Therefore, the angle between the first flange and the fourth flange is specified as being between 60° to 120° in the claims. In general, the arrangements shown in the figures will be the most practical, but variations within the actual angles should not be considered to be very critical. Even though the word “perpendicular” is also mentioned in the claims, variations away from exactly 90° should still be considered to be encompassed by the claims.

The centre hinge 6 shown in FIG. 5 is similar to the corner hinge 5 shown in FIGS. 2 and 3 but without the third and fifth flanges. However, instead of a pin which is inserted through the cylindrical elements of the hinges, a pin 80 is adjustably mounted in the cylindrical element 81 of the flange 82 which is connected to the sash element. The cylindrical element of this flange is arranged above the cylindrical element 83 of the flange 84 which is connected to the frame member. The pin comprises an outside threaded portion 85 which is arranged in an inside threaded portion 86 of the cylindrical element 81 of the sash flange 82. By rotating the pin with an Allan (hex) key in the hex recess 87 in the top of the pin 80, the pin can be moved up or down in the cylindrical portion 81 of the sash flange 82. The lower end 88 of the pin has a reduced diameter with respect to the outer threaded portion 85 of the pin. The shoulder 89 between the lower end 88 and the threaded portion 85 of the pin rests on the upper surface 90 of the cylindrical portion 83 attached to the flange 84 attached to the frame member. This allows the height of the sash to be adjusted with respect to the frame.

As with the corner hinges, the portion of the flange which is closest to the cylindrical portion has been offset from a plane which goes through the pivot axis of the hinge. Again, this allows the rearwardly protruding flange 50 of the sash element to rotate without interfering with the hinge flanges. The centre hinge 6 is attached to the sash element and the frame member in the same way as the corner hinge shown in FIG. 2. In addition, the flange 82 which is connected to the sash has a protrusion 47 which is engaged with the shallow recess 46 in the sash element. This again increases the strength of the connection between the hinge and the sash.

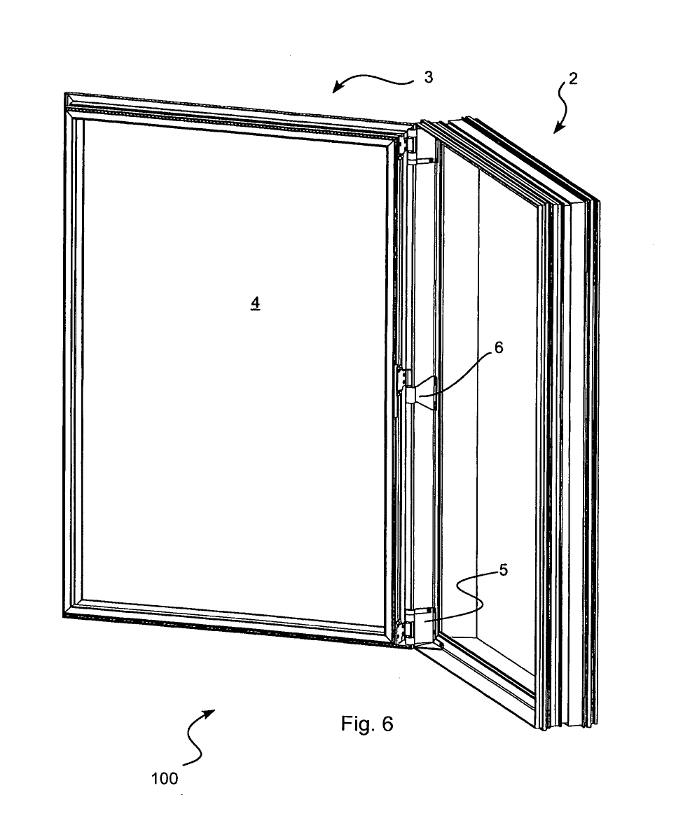

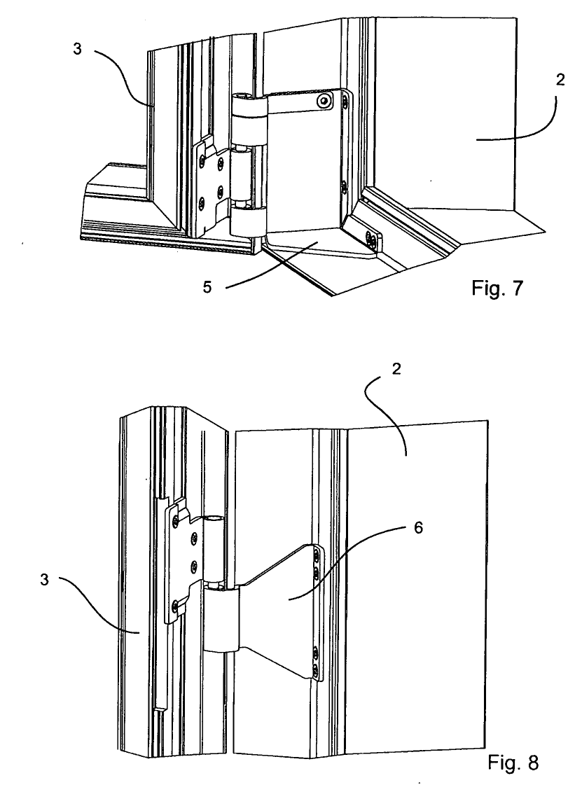

FIG. 6 shows a perspective view of another outwardly opening window 100 comprising hinges according to the invention. FIG. 7 shows a detailed view of the lower corner hinge and FIG. 8 shows a detailed view of the centre hinge when they are mounted on the frame and the sash. Since the majority of the details of the hinges are the same as those described above with respect to FIGS. 1-5, the same reference numerals will be used for similar features.

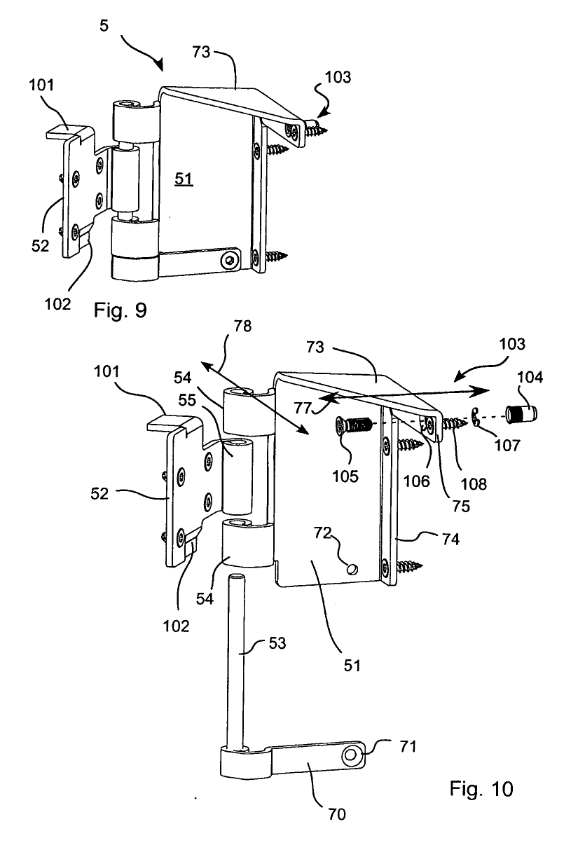

FIGS. 9 and 10 shows a detailed and an exploded view respectively of the top corner hinge of FIG. 6. As can be seen, the hinge is substantially identical to the one of FIGS. 2 and 3. Therefore the reader is referred to the description of the hinges of FIGS. 2 and 3 to understand the hinge of FIGS. 9 and 10.

There are a number of minor differences between the two hinges (FIGS. 9+10 and FIGS. 2+3), but there are three main differences. The first difference is that the second flange 52 which is connected to the sash, comprises a sixth flange 101 which is arranged perpendicular to the second flange 52 and which is attached to a second sash member. In this case, the sixth flange is not fastened directly to the second sash member, but is engaged with the second sash member via the groove 46 on the second sash member. In this way, the sixth flange helps to strengthen the sash of the window assembly at the corners.

The second difference is that the protrusion 47 of the second flange of the embodiment shown in FIGS. 2-3 is replaced with a bent flange 102. The bent flange is arranged such that it engages with the groove 46 in the sash. The bent flange is simpler to manufacture since it is a pure bending operation instead of a forming operation as the protrusion of the embodiment shown in FIGS. 2 and 3.

The final difference is that the screw adjusting mechanism 103 is shown. The screw adjusting mechanism 103 comprises an insert 104 with an internal thread which is firmly fixed (for example press fitted or glued) to the frame, a screw 105 which is arranged in a hole 106 on the fifth flange 75 of the hinge and a circlip 107 which engages with the screw 105 and is arranged such that the screw is axially locked in position with respect to the fifth flange, but is free to rotate about its longitudinal axis. When the hinge is mounted on the window frame, the screw is arranged such that it is engaged with the internal thread of the insert. As the screw is rotated, the fifth flange is therefore pulled towards the frame member or pushed away from the frame member depending on the direction of rotation of the screw. As the fifth flange is pulled towards or pushed away from the frame, the pivot axis of the hinge will move away from the frame or towards the frame respectively. In this way, it is easy to adjust the position of the window. When the window is in the correct position, the second screw 108 is tightened, thereby locking the position of the hinge.

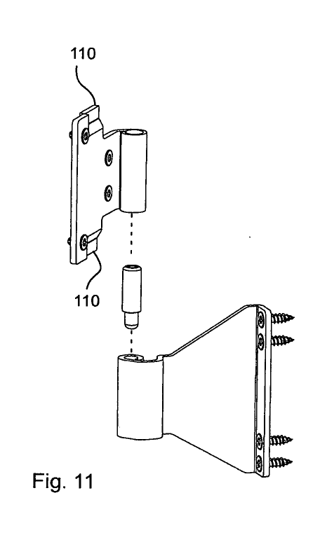

The centre hinge shown in FIG. 11 is very similar to the one shown in FIG. 5 and as such won't be described in great detail here. The reader is referred to the description with regards to FIG. 5. The main difference between the two embodiments is that the embodiment shown in FIG. 11 has a bent metal flange 110 on the flange which is attached to the sash, instead of a protrusion 47 as was the case with the previous embodiment.

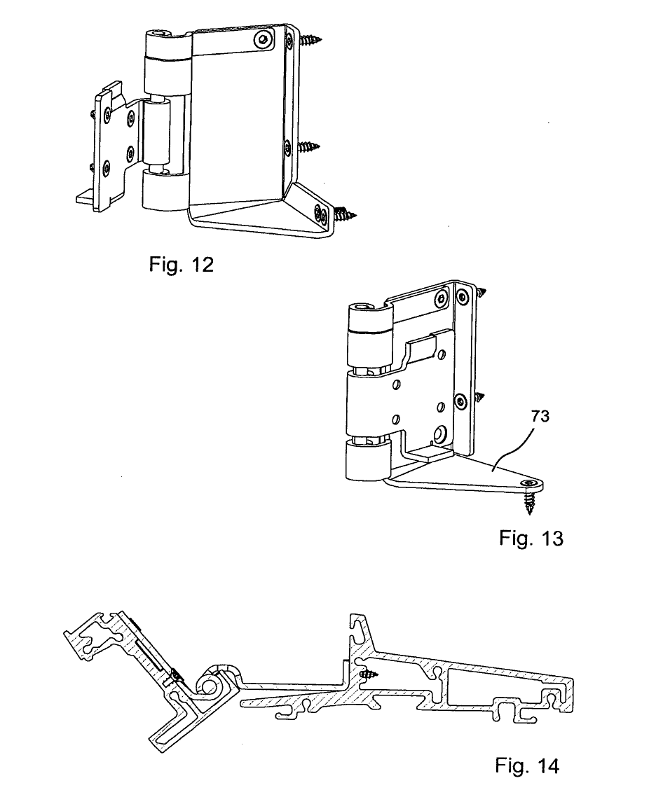

FIGS. 12-14 are included for the sake of completeness. FIG. 12 shows a bottom corner hinge which is equivalent to the top hinge shown in FIGS. 9 and 10 but mirrored about a horizontal axis. FIG. 13 shows a bottom corner hinge without a fifth flange. This hinge is used in cases where a low frame height is required on the lowermost frame member. This is typically the case in a door application. In this application, the third flange 73 is directly screwed into the frame member. This is possible since in these types of applications, the lowermost frame member can be made much stronger than the standard frame members. FIG. 14 is for the most part identical with FIG. 4.

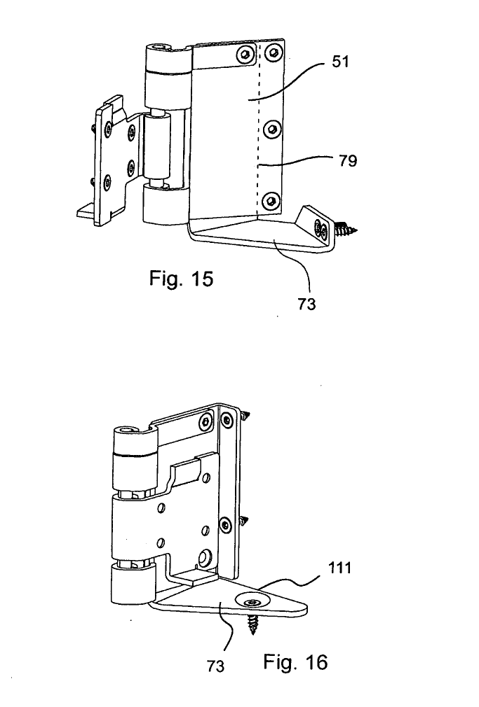

FIG. 15 shows a variation of the hinge of FIG. 12. In this case, the first flange 51 does not have fourth flange which is fastened to the frame member. instead in this embodiment, the first flange 51 itself is fastened to the frame member. However, the screws which are used to fasten the flange to the frame member are all placed at one side of the flange. This allows the flange to bend along a bending line 79 located on the outer side of the screws used to attach the flange to the frame member. It can also be seen that the third flange 73 is not attached to the first flange at the innermost side of the first flange. This also allows the first flange to bend more deterministically. The bend line 79 could furthermore (not shown) be formed to further enhance the bending. For example the material along the bending line could be made thinner than the rest of the flange.

FIG. 16 is a variation of the corner hinge shown in FIG. 13. The difference here is that instead of a simple screw which attaches the third flange 73 to the frame member, an eccentric mechanism 111 is used. By turning the eccentric mechanism located in the third flange, the third flange can be forced to move in or out. The solution shown in FIG. 16 is very schematic, but the person skilled in the art should be able to provide alternative solutions.

It should be noted that the embodiments shown in the figures have all been used together with outwardly opening windows. However, many of the inventions disclosed in this specification can also be used with inwardly opening windows or with doors.

1. A hinge (5) suitable for a window or door assembly comprising a frame (2) and a sash (3) pivotably arranged with respect to each other, where said frame is of the type comprising four frame members (2a-2d) arranged in a rectangular arrangement and where said sash is of the type comprising four sash members (3a-3d) arranged in a rectangular arrangement, where said hinge comprises a first flange (51) arranged to be fixed to a first frame member (2d) and a second flange (52) arranged to be fixed to a first sash member (3b) and where the two flanges are pivotably connected to each other about a pivot axis which is arranged parallel to the longitudinal axis of said first frame member and said first sash member, and where said hinge further comprises a third flange (73) which is attached to said first flange and which is arranged essentially perpendicular to the first flange, said third flange being arranged to be fixed to a second frame member (2a), said second frame member being arranged essentially perpendicular to the first frame member, characterized in that said hinge further comprises a fourth flange (74) which is attached to said first flange and which is arranged at an angle to the first flange of between 60° and 120°, said fourth flange being arranged to be fastened to the first frame member.

2. A hinge (5) according to claim 1, characterized in that said third flange (73) is arranged essentially perpendicular to the plane of the frame (2).

3. A hinge (5) according to claim 1, characterized in that said fourth flange (74) is arranged essentially parallel with the plane of the frame (2).

4. A hinge (5) according to claim 1, characterized in that said hinge further comprises a fifth flange (75), which is attached to said third flange (73) and which is arranged at an angle to the third flange of between 60° and 120°, said fifth flange arranged to be fastened to said second frame member (2a).

5. A hinge (5) according to claim 1, characterized in that the hinge further comprises a sixth flange (101) which is attached to said second flange (52) and which is perpendicular to the second flange, said sixth flange being arranged to be fixed to a second sash member (3a), said second sash member being arranged perpendicular to the first sash member.

6. A hinge (5) according to claim 4, characterized in that said fourth (74) and fifth flanges (75) are not directly attached to each other.

7. A hinge (5) according to claim 1, characterized in that said hinge further comprises an adjusting mechanism (103) connected to said third flange (73) whereby the end of the third flange which is opposite the first flange (51) can be displaced along a vector (77) which is perpendicular to the plane of the frame (2) and where the hinge is arranged such that displacement of said end of the third flange via said adjusting mechanism displaces the location of the pivot axis of the hinge along a vector (78) which is perpendicular to the first flange.

8. A hinge (5) according to claim 7, characterized in that said adjustment mechanism (103) comprises an eccentric mechanism (111) which is placed on the third flange (73) at the end opposite the first flange (51) and which is arranged such that the eccentric motion is arranged in the plane of the third flange.

9. A hinge (5) according to claim 4, characterized in that said hinge further comprises a fifth flange (75), which is attached to said third flange (73) and which is arranged at an angle to the third flange of between 60° and 120°, said fifth flange arranged to be fastened to said second frame member (2a), and said adjusting mechanism (103) comprises a screw mechanism (104,105,107) having an axis which is perpendicular to the plane of the frame (2) and which passes through the fifth flange (75).

10. A hinge (5) according to claim 9, characterized in that said screw mechanism comprises an insert (104) with an internal thread, said insert being fixed to the frame (2), a screw (105) with an external thread which is arranged axially fixed but free to rotate with respect to the fifth flange (75), and where said insert and said screw are arranged coaxially and where said screw is engaged with said insert, such that rotation of said screw causes the fifth flange to displace along a vector (77) which is perpendicular to the fifth flange.

11. A hinge (5) suitable for a window or door assembly comprising a frame (2) and a sash (3) pivotably arranged with respect to each other, where said frame is of the type comprising four frame members (2a-2d) arranged in a rectangular arrangement and where said sash is of the type comprised of four sash members (3a-3d) arranged in a rectangular arrangement, where said hinge comprises a first flange (51) arranged to be fixed to a first frame member (2d) and a second flange 52 arranged to be fixed to a first sash member (3b) and where the two flanges are pivotably connected to each other about a pivot axis which is arranged parallel to the longitudinal axis of said first frame member and said first sash member, and where said hinge further comprises a third flange (73) which is attached to said first flange and which is arranged perpendicular to the first flange, said third flange being arranged to be fixed to a second frame member (2a), said second frame member being arranged perpendicular to the first frame member, characterized in that said hinge further comprises an adjusting mechanism (103) connected to said third flange (73) whereby the end of the third flange which is opposite the first flange can be displaced along a vector (77) which is perpendicular to the plane of the frame and where the hinge is arranged such that displacement via said adjusting mechanism displaces the location of the pivot axis of the hinge along a vector (78) which is perpendicular to the first flange.

12. A hinge (5) suitable for a window or door assembly comprising a frame (2) and a sash (3) pivotably arranged with respect to each other, where said frame is of the type comprising four frame members (2a-2d) arranged in a rectangular arrangement and where said sash is of the type comprised of four sash members (3a-3d) arranged in a rectangular arrangement, where said hinge comprises a first flange (51) arranged to be attached to a first frame member (2d) and a second flange (52) arranged to be attached to a first sash member (3b) and where the two flanges are pivotably connected to each other about a pivot axis which is arranged parallel to the longitudinal axis of said first frame member and said first sash member, and where the first flange comprises a cylindrical element (54) arranged parallel with the longitudinal axis of the first frame member and the second flange comprises a cylindrical element (55) arranged parallel with the longitudinal axis of the first sash member and that the first and second flanges are pivotably connected together via a pin (53) arranged in said cylindrical elements characterized in that said pin comprises a tab (70) which is arranged at one end of the pin and which is arranged such that the plane of the tab is arranged parallel to the axis of the pin.

13. A hinge (5) according to claim 12, characterized in that the dimension of the tab (70) in a direction perpendicular to the axis of the pin is greater than the dimension of the tab in the direction which is parallel to the axis of the pin.

14. A hinge (5) according to claim 12, characterized in that tab comprises means (71) for fastening the tab to the first flange (51) of the hinge.

15. A hinge (5) according to claim 14, characterized in that the means (71) for fastening the tab to the first flange (51) comprise a hole (71) in the tab and a corresponding threaded hole in the first flange whereby a screw is insertable through the hole in the tab and into the corresponding threaded hole in the first flange.
